(19) United States
(12) Patent Application Publication
(10) Pub. No.: US 2003/0026068 A1
(43) Pub. Date: Feb. 6, 2003

(54) Portable computing device with foldable display panels

(76) Inventors: Wen-Sung Tsai, Taipei (TW); Chung-Chi Chien, Taipei (TW)

Correspondence Address: NAIPO(North America International Patent Office), P.O. Box 506, Merrifield, VA, 22116, US

(21) Appl. No.: 09/683,724

(22) Filed: Feb. 7, 2002

(30) Foreign Application Priority Data
Jul. 31, 2001 (TW) 090118564

(51) Int. Cl. G06F 1/16

(52) U.S. Cl. 361/683; 361/680; 361/681

(57) ABSTRACT

A portable computing device has two bodies and a central processing unit (CPU) to control the portable computing device. Each body has a contact surface, a rotation axle disposed along a side of the contact surface, and a display panel for displaying images. The two bodies are rotationally connected to each other by the rotation axles such that the two contact surfaces of the bodies are capable of rotating along the respective rotation axles to contact each other. When the two bodies contact each other, the respective two display panels are both hidden.

### BACKGROUND OF INVENTION

1. Field of the Invention

The invention relates to a portable computing device, and more particularly, to a portable computing device with foldable display panels.

2. Description of the Prior Art

In accordance with recent technical developments, various types of personal computers, such as desktop, tower, and notebook types, have been developed and are being sold on the market. The notebook computers, designed while taking portability into consideration, are compact and light. Lately, portable computing devices, such as personal digital assistants (PDA), which are smaller than notebook computers, have appeared.

In designing portable computing devices, physical dimension is an important concern. It is highly desirable to design a portable computing device that is petite enough to be held in a user's palm. However, a display panel's size is also minimized with the reduced physical dimension of the portable computing device. Please refer to FIG. 1. FIG. 1 is a perspective view of a portable computing device 10 according to the prior art. The prior art portable computing device 10 has a plurality of control buttons 16 to control the portable computing device 10. A display panel 14 is disposed on a surface 12 of the portable computing device 10 to display images. Since the display panel 14 is disposed on the surface 12, as the physical dimension of the portable computing device 10 is reduced, the display panel size 14 is minimized and the area of the display panel 14 is sacrificed.

A display panel in a portable computing device provides a friendly graphic user interface (GUI) for a user to operate the device. Through the display panel, the user can access information in the portable computing device. A large display panel not only allows comfortable viewing, it also improves correctness of input. A large display panel is especially important for devices with pen-based input means. Nevertheless, since the area of the surface 12 of the portable computing device 10 restricts the area of the display panel 14, several shortcomings arise in the prior art portable computing device.

First, since the user has difficulty effectively operating the portable computing device through a small display panel, accessing information in the portable computing device is difficult. Furthermore, since the size of the display panel is limited, data or information shown on the prior art portable computing device is either divided into several parts or shrunk to fit in with the small screen. However, either way leads substantial degradation in operational efficiency and convenience of use.

### SUMMARY OF INVENTION

It is therefore a primary objective of the claimed invention to provide a portable computing device with foldable display panels to solve the above-mentioned problem.

According to the claimed invention, the portable computing device comprises two bodies and a central processing unit (CPU) to control the portable computing device. Each body has a contact surface, a rotation axle disposed along a side of the contact surface, and a display panel for displaying images. The two bodies are rotationally connected to each other by the rotation axles such that the two contact surfaces of the bodies are capable of rotating along the respective rotation axles to contact each other. When the two bodies contact each other, the respective two display panels are both hidden.

It is an advantage of the claimed invention that the portable computing device has foldable display panels capable of minimizing physical dimension and maximizing viewing area to overcome the prior art shortcomings.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a portable computing device according to the prior art.

FIG. 2A is a front view of a portable computing device according to a preferred embodiment of the present invention.

FIG. 2B is a front view of the portable computing device when two bodies of the portable computing device are in a direction of being folded.

FIG. 2C is a front view of the portable computing device when the two bodies are folded.

FIGS. 3A to 3C are corresponding rear views of the portable computing device shown in FIGS. 2A to 2C.

FIG. 4 is an enlarged sectional view of a fixing mechanism when the portable computing device is folded.

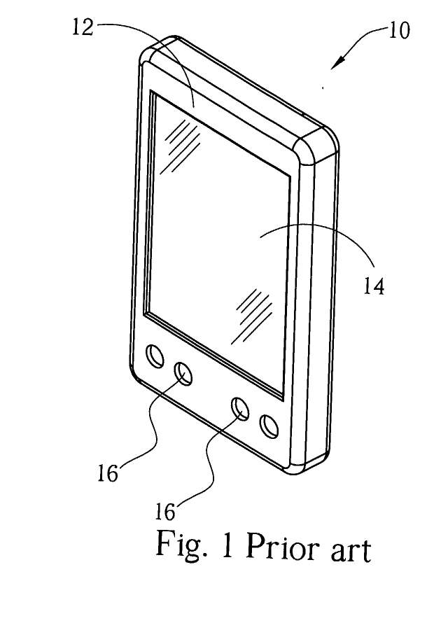

### DETAILED DESCRIPTION

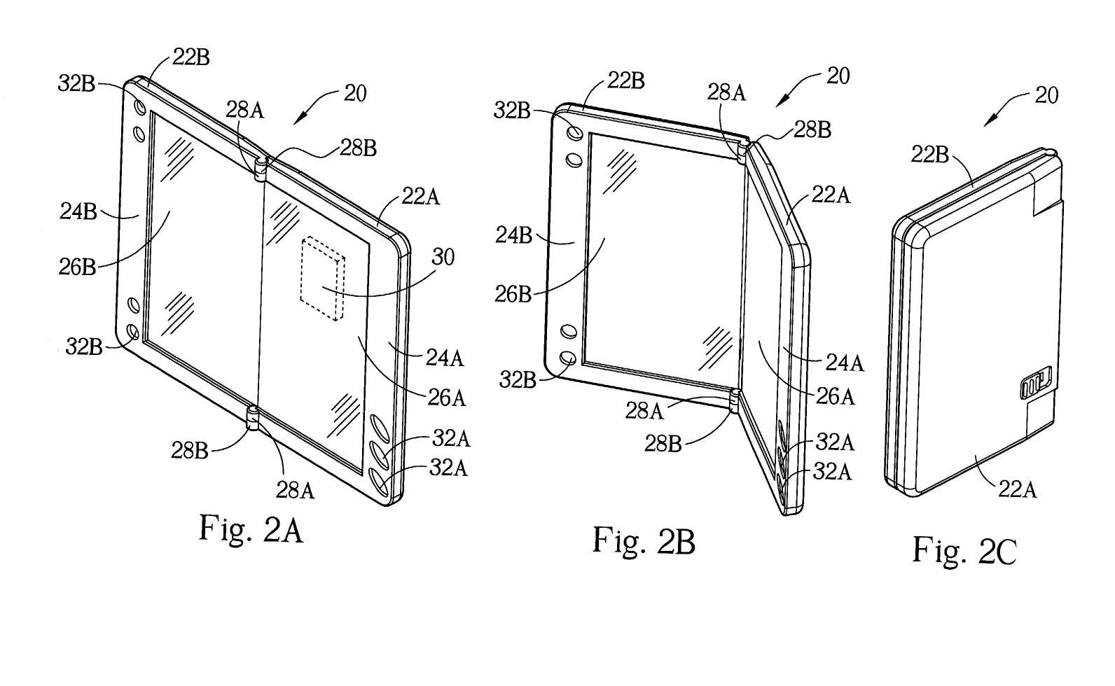

Please refer to FIG. 2A. FIG. 2A is a front view of a portable computing device 20 according to a preferred embodiment of the present invention. The portable computing device 20 comprises two bodies 22A, 22B. Each body has a respective contact surface 24A, 24B, and a respective rotation axle 28A, 28B disposed along a side of the contact surface 24A, 24B. The two bodies 22A, 22B are rotationally connected to each other, like a hinge, by the rotation axles 28A, 28B such that the two contact surfaces 24A, 24B of the bodies 22A, 22B can rotate along the respective rotation axles 28A, 28B to contact each other. Two display panels 26A, 26B are respectively disposed on the contact surfaces 24A, 24B of the two bodies 22A, 22B to display images. A plurality of control buttons 32A, 32B such as a power switch and an operational mode switch may be respectively disposed on the two bodies 22A, 22B to operate the portable computing device 20. Surely, a central processing unit (CPU) 30 is also installed in the portable computing device 20 of the present invention. As shown in FIG. 2A, the CPU 30 is installed in the interior of the body 22A to control the portable computing device 20.

The two bodies 22A, 22B of the portable computing device 20 can be pivoted with respect to each other about the rotation axles 28A, 28B. Please refer to FIGS. 2B and 2C. FIG. 2B is a front view of the portable computing device 20 when the two bodies 22A, 22B are in a direction of being folded. FIG. 2C is a front view of the portable computing device 20 when the two bodies 22A, 22B are folded. As shown in FIG. 2B, the two bodies 22A, 22B are pivoted with respect to each other about the rotation axles 28A, 28B such that the two contact surfaces 24A, 24B are moved gradually from the unfolded position as shown in FIG. 2A to the fully folded position as shown in FIG. 2C so as to contact each other. When the two bodies 22A, 22B contact each other, the respective two display panels 26A, 26B disposed respectively on the two contact surfaces 24A, 24B are in opposition to each other and both hidden inside the bodies 22A, 22B.

A distinguishing characteristic of the portable computing device 20 disclosed in the present invention is the two display panels 26A, 26B provided on the two bodies 22A, 22B. When the two bodies 22A, 22B are fully unfolded as shown in FIG. 2A, the two display panels 26A, 26B disposed on the two bodies 22A, 22B are merged into a display panel with a large area, thus increasing substantially the ability of displaying information on the portable computing device 20 in the present invention. For example, when a user reads an electronic book on the portable computing device 20, the display panel 26A on the body 22A is used to display the right half pages of the electronic book, and then the display panel 26B on the body 22B is used to display the left half pages of the electronic book. Consequently, all the documents can be read without reducing their font size. Likewise, when a user browses a website on the portable computing device 20, the web pages can be displayed across the two display panel 26A, 26B to be viewed completely at one time.

Moreover, when the two display panels 26A, 26B are in a fully unfolded position, the displaying area is instantly doubled, thus allowing the portable computing device 20 the most convenient interface. For instance, the two display panels 26A, 26B may be touch-sensitive display panels to be used as handwriting areas for handwriting input with a stylus. When the display panel 26A is used as the handwriting area, the display panel 26B can instantly display the inputted contents so as to assure the correctness. Additionally, when the portable computing device 20 runs translation software, such as Chinese-English translation, the content of one language can be displayed on the display panel 26A, and then the corresponding content of the other language can be displayed on the display panel 26B.

When the portable computing device 20 is folded as shown in FIG. 2C, the display panels 26A, 26B are hidden inside the portable computing device 20 and an excellent protection is provided for the fragile display panels 26A, 26B. At this time, the physical dimension of the portable computing device 20 is also reduced. That is to say, by being able to fold the display panels 26A, 26B when not in use and unfold them during use, the physical dimension of the portable computing device 20 can be substantially reduced without compromising the comfortable viewing desired by the users.

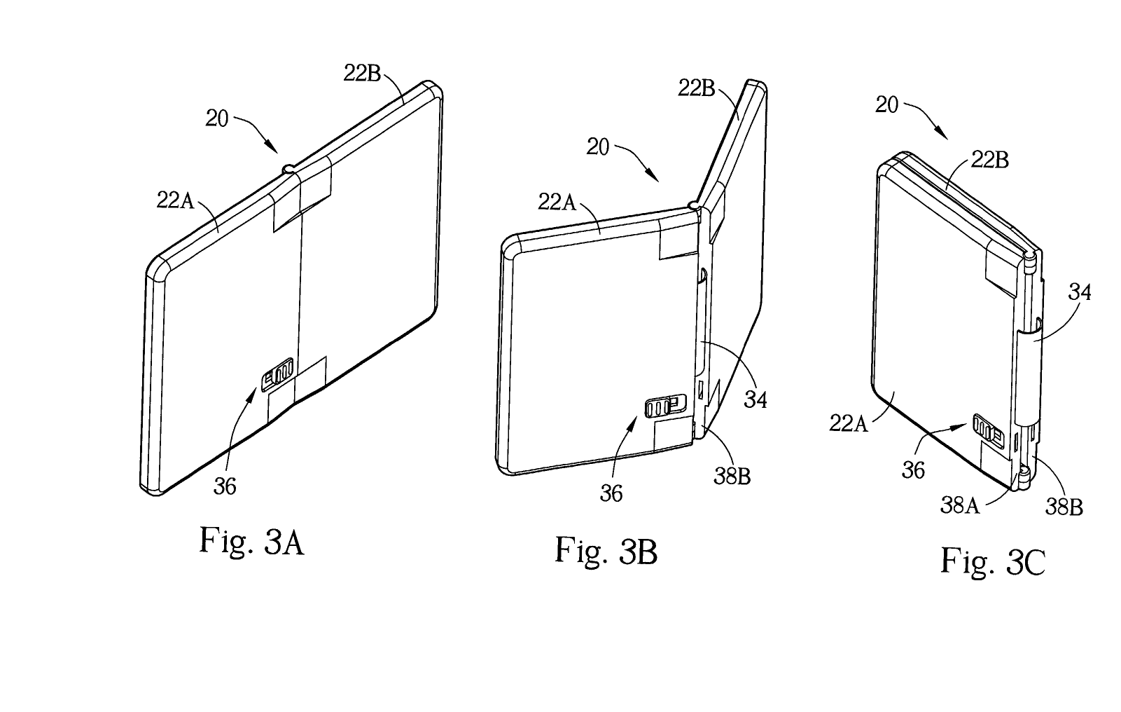

Please refer to FIGS. 3A to 3C. FIGS. 3A to 3C are corresponding rear views of the portable computing device 20 shown in FIGS. 2A to 2C. As shown in FIGS. 3B and 3C, the portable computing device 20 utilizes a bus 34 mounted on a soft circuit board to exchange electronic signals. When the two bodies 22A, 22B of the portable computing device 20 are unfolded as shown in FIG. 3A, two side walls 38A, 38B adjacent to the rotation axles 28A, 28B of the two bodies 22A, 22B, as shown in FIG. 3C, contact each other tightly so as to unfold the bodies 22A, 22B firmly. A fixing mechanism can also be installed on the portable computing device 20 to fix the two bodies 22A, 22B as the portable computing device 20 is unfolded. As shown in FIGS. 3A to 3C, the portable computing device 20 has the fixing mechanism 36.

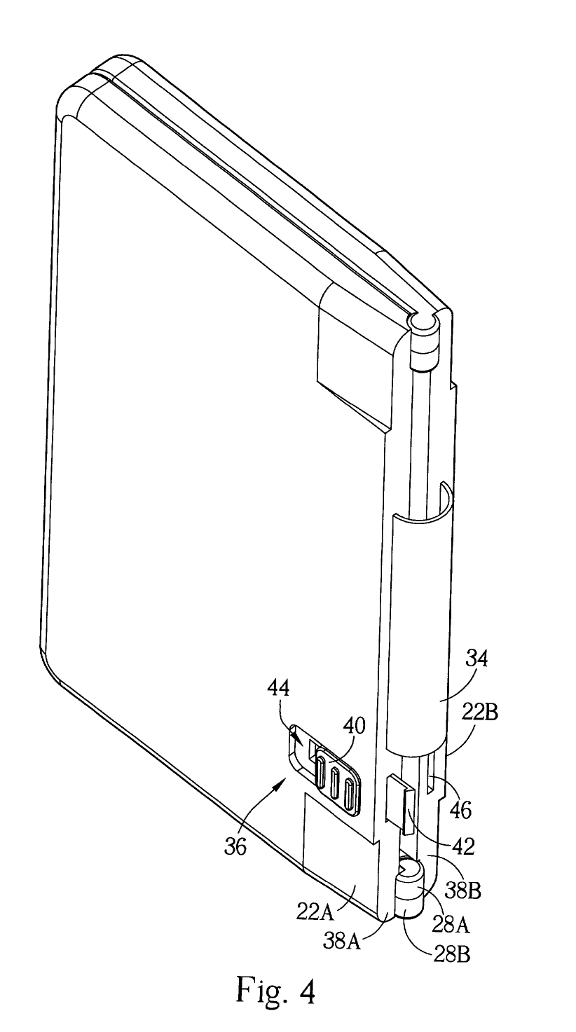

Please refer to FIG. 4. FIG. 4 is an enlarged sectional view of the fixing mechanism 36 when the portable computing device 20 is folded. In the preferred embodiment of the present invention, the fixing mechanism 36 installed on the outer surface of the body 22A has an actuator 40 and a bolt 42 fixed on the actuator 40. When the actuator 40 slides along a slot 44 back and forth, the bolt 42 is protruded from or drawn back to the side wall 38A. Besides, a fillister 46 is installed on the body 22B corresponding to the bolt 42. When the portable computing device 20 is unfolded as shown in FIG. 3A, the actuator 40 is slid along the slot 44 toward the side wall 38A to protrude the bolt 42 from the side wall 38A and insert the bolt 42 into the fillister 46 on the side wall 38B so as to fix the two bodies 22A, 22B.

In summary, in the prior art, the portable computing device has only one display panel, the user has difficulty operating effectively and accessing information through the small display panel of the portable computing device. Furthermore, since the dimension of the display panel is limited, data or information shown on the prior art portable computing device is either divided into several parts or shrunk to fit in with the small screen. However, either way leads substantial degradation in operational efficiency and convenience of use.

In contrast to the prior art, the portable computing device according to the present invention provides foldable display panels to be merged into a display panel with a large area. Therefore, the ability to display information on the portable computing device is increased substantially. Moreover, when the two display panels are in a fully unfolded position, the displaying area is instantly doubled, thus allowing the portable computing device the most convenient interface. Additionally, when the portable computing device is folded, the display panels are hidden inside the portable computing device and an excellent protection is provided for the fragile display panels. At this time, the physical dimension of the portable computing device is also reduced to half the size. That is to say, by being able to fold the display panels when not in use and unfold them during use, the physical dimension of the portable computing device can be substantially reduced without compromising the comfortable viewing desired by the users.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable computing device comprising:
two bodies, each body having:
a contact surface;
a rotation axle disposed along a side of the contact surface; and
a display panel for displaying images;
wherein the two bodies are rotationally connected to each other by the rotation axles such that the two contact surface of the bodies are capable of rotating along the respective rotation axles to contact each other; and
a central processing unit (CPU) to control the portable computing device;
wherein when the two bodies contact each other, the respective two display panels are both hidden.

2. The portable computing device of claim 1, wherein the two display panels of the respective two bodies have approximately the same size.

3. The portable computing device of claim 1 further comprising a fixing mechanism, wherein when the two contact surfaces of the respective two bodies rotate outwards to form a plane, the fixing mechanism fixes the position of the two bodies such that further rotation is prevented.

4. The portable computing device of claim 1, wherein the images displayed respectively on the two display panels are capable of forming one complete image.

5. The portable computing device of claim 1 wherein the portable computing device is a personal digital assistant (PDA).

6. The portable computing device of claim 1, wherein the two display panels are touch-sensitive display panels.

7. The portable computing device of claim 1, wherein when the two bodies rotate outwards to cause the respective two contact surfaces to form a plane, the display panels of the respective bodies together form a single larger display panel.
